(19) United States
(12) Patent Application Publication
(10) Pub. No.: US 2008/0057188 A1
(43) Pub. Date: Mar. 6, 2008

(54) METHOD OF MAKING A PRINTING BLANKET OR SLEEVE INCLUDING A TEXTURIZED POLYURETHANE PRINTING SURFACE

(76) Inventors: Joseph L. Byers, Inman, SC (US); W. Toriran Flint, Asheville, NC (US); Samuel R. Shuman, Bozeman, MT (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/845,953

(22) Filed: Aug. 28, 2007

Related U.S. Application Data
(60) Provisional application No. 60/840,909, filed on Aug. 29, 2006.

(51) Int. Cl. B05D 1/12

(52) U.S. Cl. 427/180

(57) ABSTRACT

A method of making a printing blanket having a texturized printing surface is provided in which a polyurethane printing surface layer is applied to a substrate in 100% solids form in a single pass. The surface of the polyurethane layer is provided with a plurality of depressions or reservoirs which are substantially uniform in size to provide an improved surface for receiving and transferring ink.

### CROSS-REFERENCE TO RELATED APPLICATIONS

This application claims the benefit of U.S. Provisional Application No. 60/840,909, filed Aug. 29, 2006, entitled METHOD OF MAKING A PRINTING BLANKET OR SLEEVE INCLUDING A TEXTURIZED POLYURETHANE PRINTING SURFACE. The entire contents of said application are hereby incorporated by reference.

### BACKGROUND OF THE INVENTION

The present invention relates to a method of making a printing blanket or printing sleeve, and more particularly, to a method of making a printing blanket including an outer polyurethane printing surface which is texturized to receive ink therein.

One of the most common commercial printing processes is offset lithography. In this printing process, ink is offset from a printing plate to a rubber-surfaced printing blanket mounted on a blanket cylinder before being transferred to a substrate, such as paper. Typically, the printing blanket includes at least one base ply which comprises the blanket carcass and an outer printing surface layer formed from a polymeric rubber material. The printing surface layer is adapted to carry and transfer liquid printing ink. In order to ensure that the printing layer has sufficient ink carrying and transferring capacity, it is known in the art to control the texture of the printing surface by grinding the printing surface or by embossing the printing surface. Embossing may be carried out by curing the rubber surface in or against an embossed release liner, or by depositing a dusting material such as starch on the uncured rubber surface, pressing the starch into the surface, and subsequently removing the starch after the surface has been cured so as to provide an improved means of carrying and transferring the ink. See, for example, commonly assigned U.S. Pat. No. 4,751,127, the disclosure of which is hereby incorporated by reference.

However, as printing surface layers currently in use typically comprise natural or synthetic rubber materials, such materials require the use of a solvent to dissolve the rubber material so that it may be coated, in numerous thin passes, onto the base ply. The solvent must then be evaporated prior to curing. Alternatively, the natural or synthetic rubber materials may be calendared onto the base ply in a single pass, but at great expense due to the need to adequately control gauge. In both methods, the rubber materials must be cured under pressure. Typically, curing is accomplished offline by wrapping the material, which is interleaved with a release liner, around a large drum and vulcanizing it in an oven for 8 to 12 hours, depending on the length of the roll and the number of wraps on the drum. Alternatively, the material may be passed through a rotational curing system such as a Rotacure or AUMA, either inline or offline; however, such a system operates at very slow speeds.

Accordingly, there is still a need in the art for an improved method of making a printing blanket or sleeve including a printing surface having the desired texture for receiving and transferring ink without the drawbacks of prior methods.

### SUMMARY OF THE INVENTION

The present invention meets that need by providing an offset printing blanket or sleeve which utilizes a thermosetting or thermoplastic polyurethane material as the printing surface material. The use of polyurethane materials provides an advantage over previously used polymeric rubber materials as the polyurethanes are used in 100% solids form, eliminating the need for solvents. In addition, the polyurethane materials may be applied in a single pass and cured or hardened inline at relatively high speeds without the use of expensive equipment. Further, the use of polyurethane layers provides improved abrasion and cut resistance over prior art rubber compounds.

According to one aspect of the present invention, a method of making a printing blanket having a texturized printing surface is provided comprising providing a substrate; applying a polyurethane printing surface layer over the substrate; applying a particulate dusting material to the surface of the polyurethane layer; at least partially embedding the dusting material into the surface of the polyurethane layer; curing or hardening the polyurethane layer; and removing the particulate dusting material from the polyurethane layer. The resulting surface of the polyurethane layer is provided with a plurality of depressions or reservoirs which are substantially uniform in size, i.e., uniform in diameter and depth. The depressions are closely spaced apart in a substantially uniform pattern across the printing surface.

In one embodiment of the invention, the substrate to which the polyurethane layer is applied comprises a web which is transported by means of a moving support roll as the polyurethane is coated onto its surface. Such a substrate web may comprise, for example, the base layer of a printing blanket construction. Alternatively, the substrate may comprise a sleeve which is supported on a cylindrical mandrel. The mandrel is preferably rotated such that the polyurethane coating is applied to substantially the entire surface of the sleeve.

The polyurethane material used as the printing surface layer is preferably a thermosetting or thermoplastic polyurethane. The polyurethane is preferably applied in the form of a 100% solids coating. The polyurethane layer may be partially cured or hardened prior to applying the particulate dusting material as long as the dusting material can still be embedded into the polyurethane surface with the application of pressure and/or heat. The polyurethane layer is preferably fully cured or hardened after the dusting material is embedded and prior to removal of the dusting material.

The particulate material is preferably applied to the polyurethane layer by passing the polyurethane layer on the substrate web under a dusting hopper containing dusting particles. The dusting particles may comprise starch, salt, sugar, or any other particulate material having a desired uniformity of size and shape to form the desired depressions and that can be removed chemically or mechanically without deleteriously affecting the depressions formed on the layer surface. Inorganic particulate materials may also be used and may be coated with a release agent such as silicone to facilitate mechanical removal.

The dusting material is preferably removed after the polyurethane surface is fully cured or hardened by brushing and/or washing the dusting particles from the polyurethane surface. Alternatively, the particles may be dissolved using a suitable solvent or chemical agent and removed. The resulting polyurethane surface includes a plurality of spaced apart depressions or reservoirs which provide an improved surface for carrying and transferring ink.

According to another aspect of the present invention, a method of making a printing blanket having a texturized printing surface is provided which comprises providing a substrate; applying a polyurethane printing surface over the substrate; and applying an embossed roll to the surface of the polyurethane layer. The embossed roll is preferably applied to the polyurethane surface under pressure while the polyurethane is still formable, i.e., the pattern on the embossed roll is the reverse of the desired pattern to be imparted to the polyurethane layer such that raised areas on the embossed roll produce indentations in the polyurethane layer. The polyurethane is then preferably at least partially cured or hardened as it separates from the embossed roll such that the embossed area remains on the surface of the polyurethane.

The embossed roll preferably comprises a plurality of raised regions that are substantially uniform in size, i.e., uniform in diameter and elevation, and closely spaced apart in a substantially uniform pattern. The texture or surface profile formed on the polyurethane surface comprises a plurality of spaced apart depressions or reservoirs which provide an improved surface for carrying and transferring ink.

The polyurethane may be cured or hardened by a number of methods, depending on the type of polyurethane used. Where cast urethanes are used, curing is preferably initiated prior to contact with the embossed roll and proceeds at a rate such that the cast urethane is formable only under pressure by the time it contacts the embossed roll.

Where the polyurethane is a heat reactive cast urethane, the embossed roll may be heated to accelerate curing so that the cast urethane is more fully set as it leaves the embossed roll. Heat may be supplied prior to and/or after the embossed roll contacts the polyurethane surface to control the state of cure and flowability as the polyurethane enters and exits the embossing station.

Where the polyurethane comprises a moisture curable cast urethane, water may be introduced on the surface of the embossed roll to accelerate curing. Water may be introduced either prior to and/or after contact with the embossed roll to control the state of cure and flowability as the polyurethane enters and exits the embossing station.

Where the polyurethane is a UV curable cast polyurethane, the embossed roll may be translucent and include a UV light source located inside of the roll to accelerate curing. UV light may be provided prior to and/or after contact with the embossed roll to control the state of cure and/or flowability as described above.

Where thermoplastic polyurethanes are used in the present invention, heat is applied as described above with regard to heat activated cast urethanes, but for the purpose of controlling hardness of the polyurethane.

Accordingly, it is a feature of the present invention to provide a method of making a printing blanket or sleeve including a polyurethane printing surface layer which has been texturized to provide an improved surface for receiving and transferring ink. Other features and advantages of the invention will be apparent from the following description, the accompanying drawings, and the appended claims.

### BRIEF DESCRIPTION OF THE DRAWINGS

FIG. 1A is a perspective view of a slot die apparatus used in the method of forming a printing blanket in accordance with one embodiment of the present invention;

FIG. 1B is a perspective view of a slot die apparatus used in the method of forming a printing sleeve in accordance with another embodiment of the present invention;

FIG. 2A is a perspective view of a spraying apparatus used in the method of forming a printing blanket in accordance with another embodiment of the present invention;

FIG. 2B is a perspective view of a spraying apparatus used in the method of forming a printing sleeve in accordance with another embodiment of the present invention;

FIG. 3A is a perspective view of a knife coating apparatus used in the method of forming a printing blanket in accordance with another embodiment of the present invention;

FIG. 3B is a perspective view of a knife coating apparatus used in the method of forming a printing sleeve in accordance with another embodiment of the present invention;

FIG. 4 is a schematic view of the method of applying dust particles in accordance with an embodiment of the present invention; and

FIG. 5 is a schematic view of an embossed roll used to provide a texturized surface to a printing blanket in accordance with another embodiment of the present invention.

### DETAILED DESCRIPTION OF THE PREFERRED EMBODIMENTS

The methods described herein to make a printing blanket or sleeve having a texturized polyurethane surface utilize thermosetting or thermoplastic polyurethanes. We have found that the use of such polyurethanes provides advantages over the use of prior art rubber compounds in that the polyurethanes may be used as 100% solids materials. Accordingly, there is no solvent which needs to be removed prior to curing. In addition, the polyurethane surface may be applied in a single pass and cured or hardened inline at relatively high speeds without the need for expensive equipment.

Where the polyurethane compound comprises a thermosetting urethane (also referred to herein as a cast urethane or two-part urethane), the urethane is typically supplied in the form of a 100% solids material which may be warmed to a liquid state and then applied to the base ply or a substrate web or sleeve by dip coating, spray coating, reverse roll coating, knife coating, or slot die coating. The thermosetting polyurethanes are generally based on polyesters or polyethers. Polyester-based polyurethanes are preferred for use due to their chemical resistance. Depending on the specific urethane employed, the curing mechanism may comprise heat, UV, or moisture curing. Optionally, the application of heat may be used to activate and/or accelerate curing.

Suitable polyurethane casting compositions for use in the present invention are described in U.S. Pat. No. 3,211,701, the disclosure of which is hereby incorporated by reference. Such compositions comprise the reaction product of an isocyanate-terminated prepolymer with an organic chain extender or crosslinking agent (which may be a polyamine or a polyhydric alcohol) with a functionality of at least 2 and a molecular weight from 18 to 600. The isocyanate-terminated prepolymer is prepared from a hydroxyl-terminated polyester, polyether, or polybutadiene polyol or mixtures thereof having a molecular weight of 300 to 6000 and a functionality of at least 2 and optionally, a hydroxyl containing chain extending agent with a functionality of at least 2 and a molecular weight of 18 to 600, with an excess of organic diisocyanate.

If desired, cure-blocked and/or delayed-cure polyurethanes may be used which are preferably derived from either blocked isocyanates or blocked or delayed action curatives, depending on the casting method employed. Where the polyurethanes are derived from blocked isocyanates, a prepolymer such as those described above for two-component systems is reacted with a blocking group such as methylethyl ketoxime, caprolactam or other active hydrogen-containing compound prior to adding a chain extender or crosslinking agent to the system. Curing is initiated only after the mixture is applied to a substrate and heat is supplied. In the presence of heat, the blocking group is released from the original isocyanate group, thus allowing the isocyanate group to react with other active hydrogen containing entities in the matrix. Examples of suitable cure-blocked and/or delayed-cure polyurethanes include the MEKO and Caytur type systems from Chemtura.

Suitable moisture-cure polyurethanes for use in the present invention include urethane prepolymers which are isocyanate-capped polyols, such as polyesters, polyethers and polyester/polyols that do not contain any internal cross-linking agent (i.e., water cross-links the polymer and gives the desired physical properties). Typical prepolymers for moisture cured polyurethanes are the same as those described above for two component cast polyurethane systems, but normally the final free NCO content of the prepolymer for a moisture cured systems will be 5% or less while typical prepolymers used in two component cast systems range from greater than 2% up to about 12%. Preferred moisture curable polyurethanes for use are commercially available from Bayer, Futura, Sika and others.

A typical UV or radiation-curable polyurethane system contains an oligomer, which may or may not contain reactive functional groups (such as double bonds), a crosslinking agent, a reactive diluent for viscosity control, and a photosensitizer or photoinitiator. By selecting an oligomer which contains at least two points of reactive unsaturation, or a reactive diluent which contains at least two points of reactive unsaturation, a crosslinking agent may be eliminated. Control over the properties of the cured systems can be exercised via the structure of the oligomer backbone, including such factors as degree of chain-branching, types of functional groups, number and types of unsaturated bonds, molecular weight, etc.; functionality and level of crosslinking agents; nature and level of reactive diluent; kind and level of the sensitizer or photoinitiator; and the like. An exemplary oligomer is an unsaturated urethane oligomer obtained by reacting an isocyanate-functional prepolymer with unsaturated compounds containing an isocyanate-reactive active hydrogen group. The unsaturated urethane oligomers are typically the reaction product of at least one organic isocyanate compound having at least two isocyanate groups; at least one polyether or polyester polyol with a functionality of at least 2 (similar to those described above); and at least one unsaturated addition-polymerizable monomeric compound having a single isocyanate-reactive active hydrogen group such as hydroxyl ethyl(propyl)-(methyl)acrylate. Before any polymerization can occur, free radicals must first be produced via the photoinitiator. The production of free radicals by the photoinitiator is a wave length function of the actinic radiation. Once the radicals are formed, propagation of polymer growth rapidly advances through chain reaction. Suitable UV or radiation curable polyurethanes are available from companies such as Sartomer, Radcure and others.

Where the polyurethane compound comprises a thermoplastic polyurethane, such polyurethanes are typically supplied as 100% solids materials which are melted and applied as a viscous liquid to the base ply or sleeve by extrusion or slot die coating, or by heated, reverse roll coating. Alternatively, the thermoplastic polyurethane may be applied as a heat laminated film. The thermoplastic polyurethanes do not require curing as they regain all of their physical properties upon cooling and reformation as a solid after coating. Suitable thermoplastic polyurethanes for use in the present invention are polyester or polyether-based and include those commercially available from Huntsman Polyurethanes, Dow and Bayer. Polyester-based polyurethanes are preferred for use due to their chemical resistance.

It should also be appreciated that alloys of the above-described thermosetting or thermoplastic polyurethanes with conventional rubber materials such as nitrile rubber, EPDM, polysulfide, and butyl rubber may also be used.

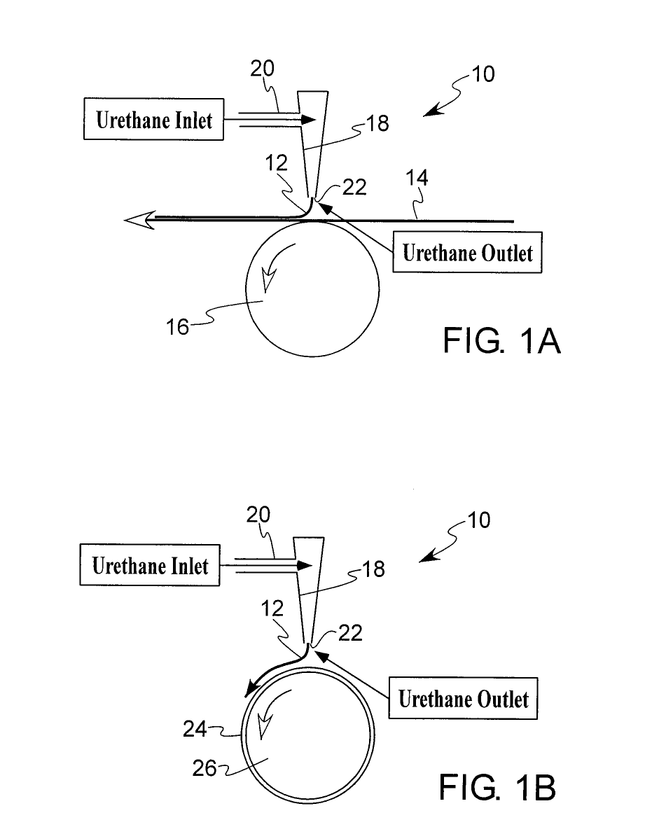

Referring now to FIG. 1A, one embodiment of the method of the present invention is illustrated in which a slot die apparatus 10 is used to apply polyurethane in the form of a flowable coating 12 onto a moving substrate web 14 which is supported by a coating or back-up roll 16. The substrate web 14 preferably comprises one or more fabric or polymeric reinforcement layers and may further include a compressible layer. The slot die is hollow and includes a blade 18. As polyurethane is pumped from inlet 20 into the interior of the die, it is dispensed through slot opening 22 onto the web. Blade 18 may be positioned to apply a predetermined thickness of polyurethane onto the substrate. The slot die apparatus may be used to apply thermosetting or thermoplastic polyurethanes.

In an alternative embodiment illustrated in FIG. 1B, a slot die apparatus 10 is shown which is used to apply a polyurethane coating 12 onto a printing blanket sleeve 24 which is provided on a rotary support or mandrel 26. The sleeve 24 preferably comprises a thin layer of metal such as nickel or a fiber-reinforced polymer resin.

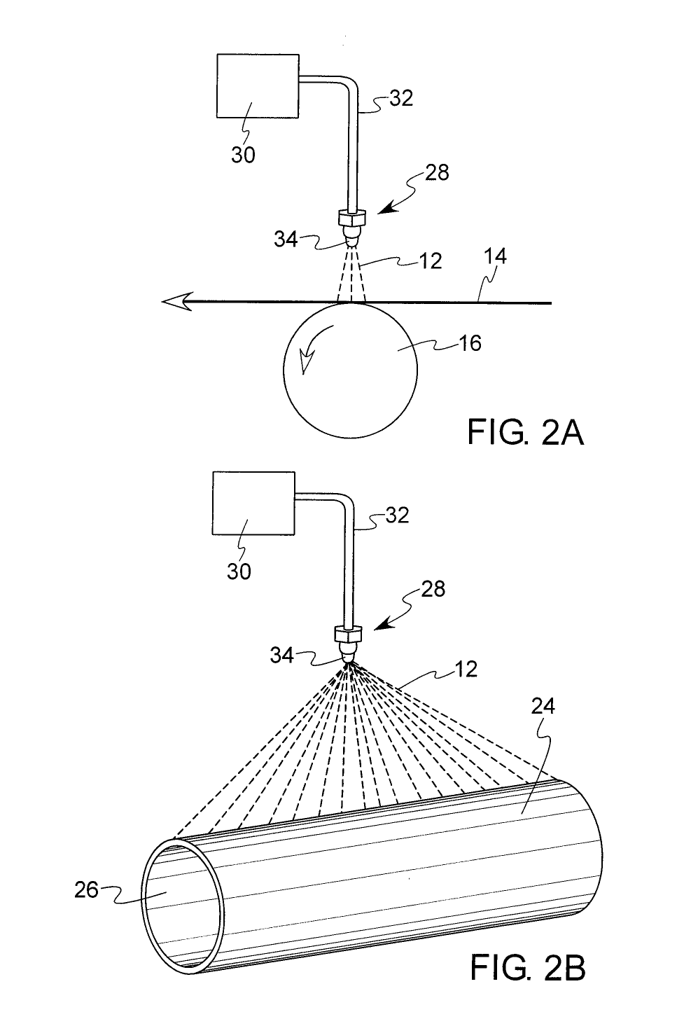

Referring now to FIGS. 2A and 2B, another embodiment of the invention is illustrated in which a thermosetting polyurethane 12 is sprayed over substantially the entire surface of a moving web 14 or a rotating sleeve 24 using a spraying apparatus 28. An example of a desirable spraying apparatus is disclosed in U.S. Pat. Nos. 5,656,677, 5,028,006 and 6,071,619, which are incorporated herein by reference. The polyurethane is preferably supplied from a tank 30. Where the polyurethane comprises a two-part polyurethane, the polyurethane may be mixed prior to being placed in the tank 30 or it may be supplied directly from the mixing unit. The polyurethane is preferably fed from tank 30 through a line 32 which supplies the polyurethane to a spray nozzle 34 for spraying directly onto substantially the entire width of the outer surface of the web 14 or sleeve 24. Where the polyurethane is sprayed onto the sleeve, the mandrel is preferably rotated during spraying to apply an even coat.

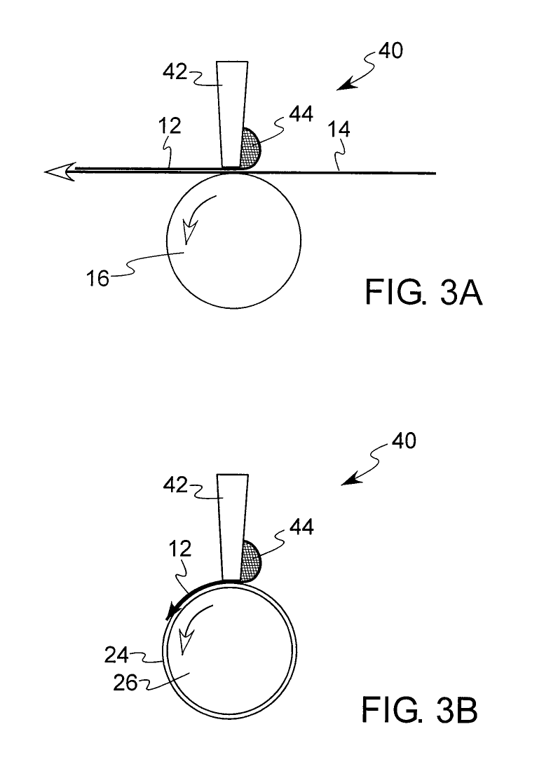

FIGS. 3A and 3B illustrate additional embodiments of the invention in which the polyurethane is knife-coated onto a substrate web or base sleeve. The knife coating apparatus 40 includes a blade 42 which functions to spread and evenly coat the polyurethane 12 as it is metered from a rolling bank 44 of the polyurethane. The knife coating apparatus may be used to coat polyurethane onto a moving substrate web 14 as shown in FIG. 3A or it may be used to coat polyurethane onto a base sleeve 24 as shown in FIG. 3B.

In one embodiment of the invention, after the substrate web or base sleeve has been coated with polyurethane by one of the above-described methods, dusting particles are deposited onto the polyurethane surface, preferably while the surface is still formable, e.g., prior to curing, where a thermosetting polyurethane is used or where a thermoplastic polyurethane is used, while the temperature of the polymer is above its softening point.

For optimum results, it is preferred that the polyurethane surface be at least partially cured or cooled prior to dispensing the dusting particles. In embodiments where a thermosetting polyurethane coating has been applied, the pot life of the coating may be such that partial curing occurs at ambient temperature prior to dispensing the dusting particles. Alternatively, the web or sleeve may be passed through a pre-curing station (not shown) downstream from the coating apparatus to initiate and/or accelerate the cure to an appropriate level prior to dispensing the dusting particles. Such a pre-curing station would include an appropriate curing source (e.g., UV, IR, RF, or radiated heat) of energy.

Where a thermoplastic polyurethane has been applied, the surface will be formable while its temperature is in excess of its glass transition temperature (T_{g}). In most instances, deposition of dusting particles can occur shortly after initial application lamination of the thermoplastic polyurethane. However, it may be necessary to warm the coating prior to deposition to provide the optimum surface for accepting the dusting particles.

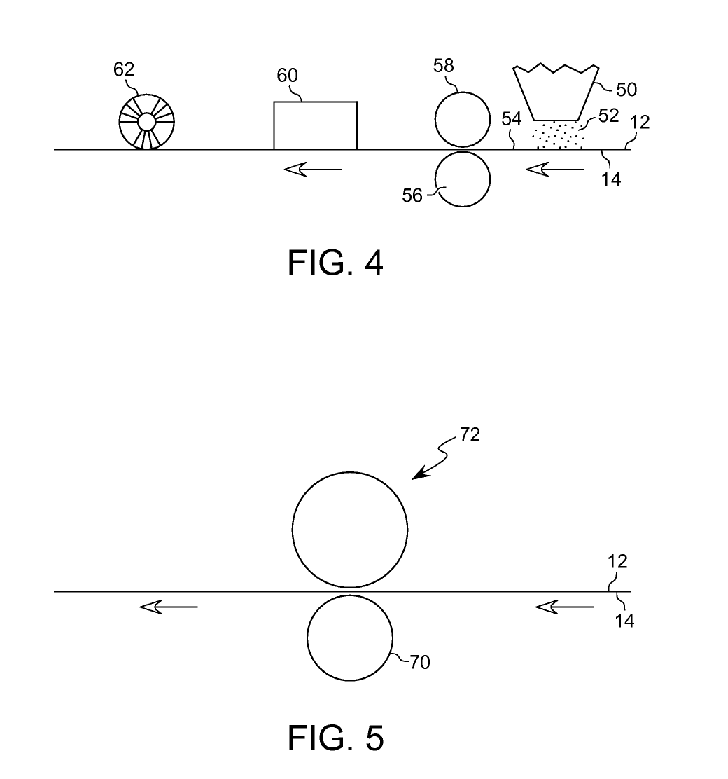

As illustrated in FIG. 4, a dusting hopper 50 positioned downstream from the polyurethane coating/pre-curing apparatus is used to deposit dusting particles 52 onto the partially cured or hardened polyurethane surface 54 of the moving web 14. Where the substrate comprises a sleeve, the sleeve is preferably positioned under the hopper and rotated.

Preferred dusting materials for use in the present invention include starch, salt, sugar, and other organic particulates. Inorganic particulates may also be used but are preferably treated with a release agent such as silicone to facilitate their removal. It should be appreciated that the dusting materials used must be inert to the polyurethane chemistry and they must have a melting point which exceeds any processing temperatures encountered while the dusting material is being applied, embedded, and/or while the polyurethane is being cured. The dusting materials must also be inert to both the surface chemistry and heat used during curing and embedding such that the dusting material is not melted, chemically distorted, or chemically bonded to the polyurethane surface, allowing the material to be readily removed after curing.

The dusting particles are preferably provided in a size which provides the resulting depressions with an average diameter of from approximately 3 microns to about 65 microns and an average depth of from about 3 to about 65 microns.

After the dusting particles 52 have been deposited onto the surface of the polyurethane on web 14, the web is passed between opposing rollers 56 and 58 which impart pressure such that the particles are pressed into the polyurethane surface 54. Where the polyurethane comprises a thermosetting polyurethane, after the particles are pressed into the polyurethane surface, the polyurethane is preferably substantially completely cured by an appropriate curing source 60 (such as UV, infrared, heat, etc.). The curing operation fixes the dust particles in position in the polyurethane surface.

Alternatively, where the polyurethane comprises a thermoplastic polyurethane, after the particles are pressed into the surface, the surface is cooled to below the T_{g} of the polyurethane.

The web 14, including the fully cured or cooled polyurethane surface 12, is then preferably passed under a rotating brush roller 62 which brushes the surface of the web 14 to remove the dusting particles 52. Where the substrate comprises a sleeve, the brush roller preferably interfaces with the sleeve surface as it is rotated.

We have found that some organic dusting materials are difficult to remove with the use of brushing alone. While organic materials such as salt and sugar can be dissolved and washed away readily with water, organic materials such as starch require additional treatment before they can be dissolved and washed away. When starch is used as a dusting material, the particles are preferably washed first with a solution of sodium hydroxide and water which breaks down the starch into a sugar so that it can be dissolved and removed from the polyurethane surface. Such a solution can be provided in the form of a bath in a reservoir (not shown) associated with brush rollers 62 such that the solution is applied using the brushes.

After removal of the dusting particles, in the areas where the embedded particles were previously present, the polyurethane surface includes a plurality of spaced apart depressions or ink reservoirs. Such depressions provide improved ink carrying and transferring characteristics.

In an alternative embodiment illustrated in FIG. 5, the printing blanket is provided with a texturized printing surface by passing the surface of the polyurethane layer 12 on the moving web 14 between a pressure roll 70 and a textured roll such as an embossed roll 72 such that the polyurethane surface is in contact with the embossed roll to provide the desired depressions on the layer surface. The roll 72 includes a plurality of raised areas (not shown) which are substantially uniform in size and spaced apart in a uniform pattern. The roll 72 is preferably formed from a material which releases easily from the polyurethane, or it may be coated with a material which aids in release such as Teflon. As the printing blanket is moved into contact with the roll, the raised areas on the roll 72 provide a plurality of spaced apart depressions or reservoirs on the polyurethane surface. Where the printing blanket is in the form of a sleeve, the sleeve is rotated such that it comes into contact with the roll 72 and the supporting mandrel provides the back-up pressure.

As previously described, curing or hardening of the polyurethane is preferably initiated prior to contact with the embossed roll such that the urethane is formable only by pressure by the time in comes into contact with the embossed roll. In this embodiment, curing may be controlled by the application of heat, moisture, or a UV light source, depending on the type of polyurethane used.

While the polyurethane is preferably cured and embossed by the above methods, it should be appreciated that prior methods used for curing rubber surfaces may be adapted to cure and emboss the polyurethane surfaces, although such methods employ more costly equipment and require more time. For example, the drum or belt in a Rotacure or AUMA may be replaced with an embossed drum or belt and employed such that the polyurethane surface is in contact with the embossed surface during heating. Alternatively, an embossed release liner may be substituted for the typical smooth release liner which is interleaved in a standard drum wrapping and curing system.

Having described the invention in detail and by reference to preferred embodiments thereof, it will be apparent that modifications and variations are possible without departing from the scope of the invention.

What is claimed is:

1. A method of making a printing blanket having a texturized printing surface comprising:
providing a substrate;
applying a polyurethane layer to the surface of said substrate, wherein said polyurethane is applied to said substrate as a 100% solids material;
providing a plurality of spaced apart depressions on the surface of said polyurethane layer for carrying and transferring ink; wherein said depressions are substantially uniform in size; and
curing or hardening said polyurethane layer to form a printing surface layer.

2. The method of claim 1 wherein said depressions have a diameter and depth of from about 3 to about 65 microns.

3. The method of claim 1 wherein providing said plurality of spaced apart depressions comprises applying a particulate dusting material to the surface of said polyurethane layer.

4. The method of claim 3 wherein said particulate dusting material is selected from starch, salt, sugar, and organic and inorganic particulates.

5. The method of claim 3 wherein said dusting material is at least partially embedded into the surface of said polyurethane layer.

6. The method of claim 3 including removing said particulate dusting material from said polyurethane layer.

7. The method of claim 1 wherein said substrate comprises the base layer of a printing blanket construction.

8. The method of claim 1 wherein said substrate comprises a sleeve supported on a cylindrical mandrel.

9. The method of claim 1 wherein said polyurethane comprises a heat reactive cast urethane, a moisture curable cast polyurethane, a UV curable cast polyurethane

10. The method of claim 3 wherein said polyurethane is partially cured prior to applying said particulate dusting material.

11. The method of claim 1 wherein providing said depressions comprises applying an embossed roll to the surface of said polyurethane layer.

12. The method of claim 11 wherein said embossed roll comprises a plurality of raised regions which are substantially uniform in size and which are spaced apart in a substantially uniform pattern.

13. The method of claim 11 wherein said embossed roll is applied to said polyurethane surface in reverse.

14. The method of claim 11 wherein said embossed roll is heated.

15. The method of claim 11 wherein said embossed roll includes a UV light source therein.

16. The method of claim 1 wherein said polyurethane is applied in a single pass.

17. The method of claim 1 wherein said polyurethane is applied in liquid form.

18. The method of claim 1 wherein said polyurethane is applied in the form of a laminated film.
